(19) United States
(12) Patent Application Publication
(10) Pub. No.: US 2023/0085184 A1
(43) Pub. Date: Mar. 16, 2023

(54) ELECTRONICS APPARATUS FOR A MOTOR VEHICLE, AND MOTOR VEHICLE

(71) Applicant: AUDI AG, Ingolstadt (DE)

(72) Inventors: Dirk Daniel BÄDER, Fellbach (DE); Michael GRABOWSKI, Ingolstadt (DE)

(73) Assignee: AUDI AG, Ingolstadt (DE)

(21) Appl. No.: 17/941,407

(22) Filed: Sep. 9, 2022

(30) Foreign Application Priority Data
Sep. 10, 2021 (DE) 10 2021 123 433.6

(51) Int. Cl. H01M 10/653; B60R 16/08; H01M 10/48; H01M 10/613; H01M 10/625; H01M 10/63; H01M 10/6567; H01M 10/6556; H01M 50/204; H01M 50/249; C09K 5/10; C09K 5/14

(52) U.S. Cl. CPC H01M 10/653; B60R 16/08; H01M 10/486; H01M 10/482; H01M 10/613; H01M 10/625; H01M 10/63; H01M 10/6567; H01M 10/6556; H01M 50/204; H01M 50/249; C09K 5/10; C09K 5/14; B60S 1/50

(57) ABSTRACT

An electronics component is protected against overheating with the aid of a liquid absorption unit. For this purpose, the electronics component, together with the liquid absorption unit are integrated into a housing device. The liquid absorption unit is made of a super-absorbent material which, when it comes into contact with an ingressing liquid, takes up the liquid and in so doing at least partially surrounds the electronics component. The super-absorbent material is selected such that it is also electrical insulating in the state in which it is fully soaked with the liquid.

### CROSS REFERENCE TO RELATED APPLICATIONS

This application is based on and claims priority under 35 U.S.C. § 119 to German Application No. 10 2021 123 433.6, filed on Sep. 10, 2021, the disclosure of which is incorporated by reference herein in its entirety.

### BACKGROUND

Described below are an electronics apparatus for a motor vehicle and a motor vehicle with such an electronics apparatus. The electronics apparatus has a housing device and at least one electronics component which is arranged in the housing device. The housing device has at least one opening for the ingress of a liquid. In order to hold the liquid, the electronics apparatus has a protection device with a liquid absorption unit for the at least one electronics component. The liquid absorption unit is integrated into the housing device and contains a super-absorbent material which is designed to take up the ingressing liquid when it comes into contact with the ingressing liquid.

Such an electronics apparatus may be, for example, a drive or traction battery, that is to say what is known as a high-voltage battery for an electric or hybrid vehicle. The device can accordingly be a battery housing or what is known as a battery box. The respective electronics components can be, for example, a battery cell or a battery module.

Aging processes or mechanical stress may cause a battery acid or an electrolyte to escape from a battery cell. The cell leaks. The leaking liquid may damage the battery housing. In addition, the liquid may escape via non-leaktight points, that is to say openings in the battery housing, and thereby damage, for example, surrounding components.

In order to avoid this, DE 103 91 977 B4 discloses a multilayer casing composed of absorbent material for a battery. In this case, the first layer has a high suction rate for the battery liquid and the second layer is designed for a high storage capacity of the battery liquid.

A similar principle is known from WO 2007/106420 A2 for example for a housing of a fuel cell. A liquid-binding or liquid-absorbing material is incorporated into the housing. This creates a leakproof fuel cell in which a liquid fuel or a liquid electrolyte can be kept in the housing.

In addition to liquid escaping from the housing, ingress of liquid into the housing may also occur. For example, the ingress of liquid may be deliberately or intentionally fostered via an incorporated opening in the housing.

In this respect, EP 2 843 727 B1 for example discloses a battery apparatus in which such an opening is provided for filling the battery housing with water. The objective is to carry out rapid discharging of the battery cells in the event of a defect or in the event of a crash. For this purpose, an electrically conductive super-absorber polymer is introduced into the housing, the super-absorber polymer taking up or sucking up the water. In so doing, the super-absorber polymer is converted into a gel-like mass and expands, with the result that electrically conductive contact is produced between a connection of the battery cell and the housing. The battery can be rapidly discharged. However, this has the disadvantage that a high electric current flows at least briefly.

### SUMMARY

Described below a way of protecting an electronics apparatus for a motor vehicle to improve handling of the electronics apparatus in the event of a defect. The apparatus is based on the finding that, for example in the event of a defect in a high-voltage battery, overheating and as a result, for example, damage to the individual battery cells can occur. In the worst-case scenario, the high-voltage battery may even catch fire. In order to cool the battery cell or to extinguish the battery, the battery housing may be filled with water for example. Water, in particular water molecules, can deploy a high cooling action due to their high thermal capacity and an enthalpy of vaporization. In order to be able to effectively utilize the cooling action, the water should be located around the source of the fire or heat similarly to a jacket or casing.

Such a “water jacket” for a battery cell presents a challenge in practice. This is because the battery housing generally does not provide sealing with respect to liquids and has, for example, an opening or leakage point. Such an opening may be, for example, a pressure-equalization element, a defective sealing element or, for example, a line break caused due to the battery being on fire. Therefore, water leaks from the housing following gravity. The water jacket and therefore a full water level in the battery housing could therefore be maintained only if water is continuously refilled in a profligate manner or the battery housing is designed in fully sealing manner at high costs and with a high level of outlay on material, even for extreme cases, such as a battery being on fire, for example. Similarly, this may also applied, for example, for other electronic assemblies of a motor vehicle, such as a controller for example.

In order to avoid such costly and complicated possible implementations, a sheathing is provided for the electronics component affected, that is to say the battery cell for example. The electronics apparatus may be used in a motor vehicle. The electronics apparatus has a housing device and at least one electronics component which is arranged in the housing device. The electronics component is therefore introduced into a volume or space in the housing device. In other words, the housing device forms a tray or tub or chest for the electronics component and can fully or partially surround the electronics component.

The housing device has at least one opening for the ingress of a liquid. The opening may be, for example, an artificial opening. In the present case, artificial is understood to mean that the opening has been deliberately or intentionally introduced into the housing device, that is to say the housing. Therefore, can, for example, can be made in a housing wall or one or more cutouts or holes. The opening can be drilled or punched or a corresponding mold can be used for the housing. In addition or as an alternative, for example at least one housing wall, that is to say one wall surface, or one wall surface portion may be replaced by a porous or permeable material. In contrast to an artificial opening, the opening may be of natural origin for example and be produced, for example, due to material properties of the housing. Therefore, the opening may be, for example, a leakage point due to aging of sealing substances or sealing lines. In addition or as an alternative, the openings may be, for example, at interfaces or connecting points between two adjacent components. Such non-leaktight points may occur, for example, during welding or screwing or adhesive bonding.

In addition, the electronics apparatus has a protection device with a liquid absorption unit. Here, the liquid absorption unit, together with the at least one electronics component, is integrated into the housing device and contains a super-absorbent material. A super-absorbent material is understood to mean what is known as a super absorber. The super-absorbent material is designed to take up and in particular to hold the ingressing liquid when it comes into contact with the ingressing liquid. The liquid is therefore bound by the super-absorbent material. The binding or holding can generally take place for as long as the liquid is in its liquid state of aggregation. If the liquid evaporates, for example due to heating, the liquid molecules may be released from the super-absorbent material in gas form (gaseous state of aggregation).

In order that the super-absorbent material does not interact for example electrically with the respective electronics component, the super-absorbent material is of electrically insulating design. The super-absorbent material is therefore a non-conductor or insulator. Here, the super-absorbent material may also exert the insulating properties in the partially or fully soaked state, that is to say in the state in which it is saturated with the liquid. A suitable non-conductive super-absorbent material is, for example, silicic acid.

If the super-absorbent material takes up the liquid, it undergoes an increase in volume. In other words, the liquid absorption unit, by way of the super-absorbent material, is designed to at least partially surround, that is to say sheath or encase, the at least one electronics component in the state in which the liquid is taken up. The quantity or the volume of the liquid may play a role here. More precisely, it can therefore be the that the liquid absorption unit, in the state in which a specified quantity or a specified volume of the liquid is taken up, to fully or partially surround the respective electronics component.

Therefore, the above-described water jacket can be formed around the respective electronics component. This has the advantage that the component can be effectively cooled without the cooling medium, specifically the liquid bound in the super-absorber, influencing the electrical properties of the electronics component and the electronics apparatus. Therefore, for example, discharging of the electronics component via the housing and as a result further heating are avoided. In the case of a defect, that is to say for example in the case of excessive heating or in the case of a battery being on fire, the handling of the electronics apparatus can be improved as a result. For example, operational reliability can be increased. An additional advantage is that the electronics component can be protected, for example against a naturally occurring liquid, such as rain or water of condensation for example, without a defect being present. Therefore, for example, a short-circuit or corrosion of electrical connections can be avoided.

The housing device of the electronics apparatus may be provided, for example, by a battery housing of a drive battery for a motor vehicle. Accordingly, the electronics component may be, for example, a battery cell or a battery module of the drive battery. Therefore, a drive battery or high-voltage battery may be assigned to the electronics apparatus as an electronic assembly. As an alternative, the housing device may be a specified component housing for an electronic device of the motor vehicle, for example for a controller or a battery management system. Accordingly, the electronics component may be, for example, a microcontroller or an integrated circuit or a specified electronic component. Therefore, an electronic device may be assigned to the electronics apparatus as an electronic assembly.

Overall, the electronics apparatus with the associated electronic assembly may also be referred to as an electronics protection apparatus for the electronic assembly of a motor vehicle, wherein the electronic assembly includes the housing device and the at least one electronics component.

The opening in the housing device is arranged upstream of the at least one electronics component for example in a direction of action of gravity. For example, the respective opening can therefore be integrated in a cover of the housing. As an alternative or in addition, the at least one opening can be integrated into the housing for example laterally, that is to say in the direction of action of gravity, next to the electronics component. Another option is to integrate the at least one opening in the housing device downstream of the electronics component in the direction of action of gravity. Therefore, the respective opening can be arranged, for example, at a base or a lower shell of the housing.

In addition to the electrically insulating super absorber, an electrically insulating liquid can also be provided for example. Even if the super absorber is oversaturated with the liquid, electrical conduction between the electronics component and the housing can be prevented in this way. In the present case, electrically insulating means that substantially no current flow through the respective medium is possible. That is to say, the respective medium provides a high degree of electrical resistance to the electric current, so that there is at most a negligibly low current flow. In addition or as an alternative, the liquid can exhibit a thermal capacity greater than a specified limit value. The limit value may be, for example, 500 J/kg·K or 1000 J/kg·K, or for example more than 2000 J/kg·K, for example 2500 J/kg·K or 3000 J/kg·K. Therefore, the liquid exhibits good thermal conductivity. That is to say, the liquid is very highly suited to cooling the electronics apparatus.

The liquid can be provided or supplied for example from outside the vehicle. For example, the liquid for extinguishing can be provided by the fire service. As an alternative, the liquid can be provided from inside the vehicle, that is to say by a system associated with the motor vehicle or integrated into the motor vehicle. Different options for providing the liquid will be discussed in more detail below.

In one embodiment, the protection device has a monitoring unit for monitoring a temperature of the at least one electronics component. The monitoring unit is designed to provide a control signal for requesting the liquid when a specified temperature overshooting is detected. This therefore involves the liquid for cooling, that is to say for dissipating heat from, the electronics component being able to be actively requested in the event of a defect. In the present case, “in the event of a defect” means the temperature overshooting being detected. This gives rise to the advantage that it is possible to identify at the earliest possible stage that the electronics component is in a critical state of overheating and should be cooled down.

In order to detect the temperature overshooting, the monitoring unit can include, for example, a temperature sensor and a controller. The temperature sensor can be used to directly detect the temperature of the electronics apparatus or the respective electronics component and transmit the temperature to the controller for comparison with a specified temperature limit value. If the measured temperature lies above the temperature limit value, the controller can determine the temperature overshooting and correspondingly generate and emit the control signal for requesting the liquid. As an alternative, the temperature of the electronics component can be monitored indirectly, for example. A current or voltage sensor, for example, can be used for this purpose. The temperature can then be determined, for example, by a specified relationship between a measured current intensity or a measured voltage or an ascertained resistance of the electronics component.

The following embodiments address how the liquid for absorption by the super-absorbent material of the liquid absorption unit can be provided to the electronics apparatus in response to the abovementioned control signal, for example.

For this purpose, provision is made in one embodiment for a liquid storage device for the motor vehicle to be assigned to the electronics apparatus. The liquid storage device has a reservoir for holding the liquid and a provision mechanism. The provision mechanism, when actuated by a control signal, is designed to provide the liquid from the reservoir to the housing device via the at least one opening. This gives rise to the advantage that the electronics apparatus itself can access the liquid. Therefore, it is not necessary for example to wait for a supply from outside the vehicle, that is to say outside the motor vehicle, in order to cool the electronics component(s) in the event of a defect.

The reservoir of the liquid storage device can be, for example, a tank or a container or a basin to be filled with the liquid. It can be connected to the opening in the housing device via the provision mechanism, for example. The provision mechanism can include, for example, a corresponding pipe or line or flow duct system for this purpose. In order to be able to control the supply or provision of the liquid in a targeted manner, the provision mechanism can include one or more closure elements or shut-off elements with corresponding control electronics. By way of actuating the control electronics using the above-mentioned control signal, the respective closure element can be opened and closed in order to allow or to interrupt a flow of liquid from the reservoir to the housing device. For example, the respective closure element can be implemented in the form of a valve or shut-off member.

According to a first variant of a further embodiment, the liquid storage device is assigned to a windshield wiper system of the motor vehicle. The liquid to be provided is therefore a wiping water solution which can be provided from a wiping water tank as the reservoir.

According to a second variant of the further embodiment, the liquid storage device is assigned to a cooling liquid system of the motor vehicle. The liquid to be provided is therefore a cooling liquid which can be provided from a cooling liquid container or tank as the reservoir. The cooling liquid system may be, for example, an existing cooling liquid system for a drive battery of the motor vehicle. This gives rise to the advantage that existing systems in a motor vehicle can be used in order to provide the liquid for absorption by the liquid absorption unit. Therefore, an existing liquid storage device inside the vehicle is used.

The following embodiments disclose how specifically the liquid absorption unit is designed and/or can be integrated into the housing.

According to one embodiment, the liquid absorption unit is provided by at least one absorption element with a geometric shaped body which is arranged in the housing device firstly at least between a housing wall and the at least one electronics component and/or secondly between two electronics components arranged adjacent in the housing device. In other words, the super-absorbent material is provided by one or more absorption elements which each have a predetermined geometric shape. The absorption element or elements can be arranged in a respective intermediate space in the housing device here, specifically in such a way that when the liquid is absorbed, contact with the respective electronics component and therefore the full or partial sheathing can be produced.

In the present case, housing wall also means, in addition to a side wall, a bottom or top surface, that is to say a base or a cover of the housing device, for example. Therefore, for example, the housing base can be partially or fully covered by the absorption element or elements of the liquid absorption unit. For this purpose, the housing apparatus can be readily filled with the absorption elements, for example, after being populated with the electronics components, until the housing base is covered. As an alternative, the filling can be performed, for example, such that absorption elements are additionally also stored in the intermediate spaces between adjacent electronics components. In addition or as an alternative, it would also be conceivable to coat the housing walls fully or partially with the at least one absorption element. Coating means, in particular, that the respective absorption element adheres to the respective housing wall independently. It is also conceivable for example to close, using the respective absorption element, for example, joints or required openings for leading cables through as it were in a liquid-tight manner using the respective absorption opening. For example, contact areas for establishing electrical or mechanical contact for example between the housing device and the respective electronics component can be excluded from the arrangement of the respective absorption element.

According to a further embodiment, the geometric shaped body is present in the following different variants, specifically as: granules, or a plate, or a film, or a rod, or a specified geometric basic shape, or an individual thread or an individual fiber, or a composite thread or a composite fiber which forms a woven fabric, that is to say a woven fabric material or a loose volume structure. This gives rise to the advantage that the geometric shape of the shaped body can be adapted to match the conditions and in particular the geometric configuration of the electronics apparatus, such as the arrangement of the electronics components in the housing device, for example.

In the present case, the granules, for example, may each be a substantially spherical element, the dimensions or diameter of which can lie in the range of from 0.5 to 3 millimeters for example. The use of granules as super-absorbent material in an absorption element gives rise to the advantage that, for example, a particularly high surface structure and therefore particularly effective absorption of water can take place. Analogously, this also applies, for example, to the configuration of the shaped body as a woven fabric or a loose volume structure. The loose volume structure can be referred to as batting for example.

In the present case, plate means a shaped body which spreads in one plane. That is to say, a length and width of the shaped body can be very much larger than a thickness or height. However, here, the thickness is selected in such a way that the plate is dimensionally stable in an unloaded state, that is to say without the action of a force. In the case of a battery cell or a battery module as the electronics component, a length and width of the plate can be matched, for example, to a dimension of the cell or the module. The plate can serve as a cell separating element, for example. A respective plate as a shaped body can be used to create, for example, a stack of one or more electronics components each with one or more absorption elements. Here, the absorption element and the electronic component alternate in the stack. Therefore, every electronics component adjoins a respective absorption element on two opposite sides. Therefore, the plate can be used for stabilizing the respective electronics component in the housing device. Such a plate can also be referred to as a disk.

Analogously to the plate, a film also means a shaped body which spreads in one plane in the present sense. That is to say, a length and width of the shaped body can be very much larger than a thickness or height. However, here, the thickness is selected in such a way that the film is not dimensionally stable, that is to say is deformable, in an unloaded state, that is to say without the action of a force. Such a film is particularly well suited for example to coating the housing wall of the electronics component.

In the present case, a rod means an elongate shaped body. That is to say, a thickness or height of the shaped body can be very much larger than a length and width. The rod can be designed, for example, as a cylindrical bar or bar with a square cross section.

A geometric basic shape can be, for example, a sphere, a pyramid or a cuboid, such as a cube for example. It goes without saying that mathematically geometric basic shapes other than those mentioned can also be used. Forming the shaped body with a geometric basic shape gives rise to the advantage that, for example, a plurality of such shaped bodies can be combined, plug-connected or stacked to form any desired new geometric shape.

The respective shaped body can be present, for example, as a solid material, that is to say a solid body, or as a hollow body.

According to a further embodiment, the geometric shaped body has a porous or perforated structure. This gives rise to the advantage that, in particular in the case of compact shaped bodies, such as the plate or film or rod or the geometric basic shape for example, the surface structure can be increased in size and therefore the absorption capability can be improved. Porous or perforated means, in particular, that the geometric shaped body can have, for example, a large number of perforation holes or openings. These holes can have, for example, a diameter of a few micrometers to a few millimeters, for example a diameter of one millimeter. Here, the perforation holes are distributed, for example, in an unspecific or disordered, that is to say arbitrary or random, manner in the material of the shaped body.

In order to ensure optimal liquid absorption for various regions in the housing device, the liquid absorption unit can have, for example, a plurality of different absorption elements each with different shaped body structures. For example, joints or required openings of the housing device or the inner walls can be coated, for example, with a film as the absorption element, while the abovementioned intermediate spaces are filled with granules.

According to a further embodiment, a plurality of flow ducts for transporting the liquid in different layers of the shaped body and/or completely through the shaped body are made in the shaped body. Particularly when the respective absorption element is implemented by a solid body, this gives rise to the advantage that the liquid can also be transported into the interior of the shaped body. Therefore, the absorption properties of the respective absorption element can be improved in this way. In contrast to the porous structure, targeted guidance for the liquid can be implemented in this way.

According to a further embodiment, the electronics apparatus has a battery arrangement, that is to say a drive battery or starter battery for example, for a motor vehicle. Here, the housing device of the electronics apparatus is provided by a battery housing of the battery arrangement and the electronics component of the electronics apparatus is provided by a battery element of the battery arrangement. The battery arrangement may be, for example, a drive battery or a starter battery of the motor vehicle. Therefore, it may be, for example, a high-voltage battery or a low-voltage battery. The battery housing may be, for example, a battery tray or a module housing for a battery cell module. The battery element may be, for example, an individual battery cell or a battery module with a plurality of battery cells.

Instead of the battery arrangement, the electronics apparatus can also be used, for example, for a controller or control system, such as a battery management system for example.

The motor vehicle includes an electronics apparatus as has been described above.

The motor vehicle may be, for example, as a passenger car or heavy goods vehicle, or as a passenger bus or motorcycle.

The features of the described embodiments may have implementations which each have a combination of the features of several of the described embodiments, provided that the embodiments have not been described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic illustration of an electronics apparatus which includes a super-absorbent material for protecting against the ingress of liquid and/or cooling an electronics component;

FIG. 2a is a schematic illustration of a first possible configuration of the super-absorbent material as granules;

FIG. 2b is a schematic illustration of a second possible configuration of the super-absorbent material as a cuboid;

FIG. 2c is a schematic illustration of a third possible configuration of the super-absorbent material in the form of a rod; and

FIG. 2d is a schematic illustration of a fourth possible configuration of the super-absorbent material in the form of a plate.

### DETAILED DESCRIPTION

In the exemplary embodiments explained below, the described components of the embodiments each represent individual features which are to be considered independently of one another and each also develop the invention independently of one another and therefore includes combinations of the features of the embodiments other than those illustrated. Furthermore, the described embodiments are also supplemented by further features already described.

In the figures, identical reference characters refer to respectively functionally identical elements.

What is known as a high-voltage battery can be used as the drive battery in battery-operated motor vehicles (BEV—battery electric vehicle), such as electric or hybrid vehicles for example. Such a high-voltage battery, also called battery below, is constructed for example from a battery housing, also called housing below, and a plurality of battery modules. In the present case, battery module means a suitable electrical circuit of one or more battery cells which together are installed into a module housing. Owing to a defect in the battery module, for example a short-circuit of the individual cells, or on account of aging processes, the battery module may be adversely affected. In this case, the battery module may, for example, heat up and in the worst-case scenario overheat and be damaged. As a result, other battery modules in the high-voltage battery may also be influenced as a chain reaction, with the result that in the worst-case scenario the battery catches fire.

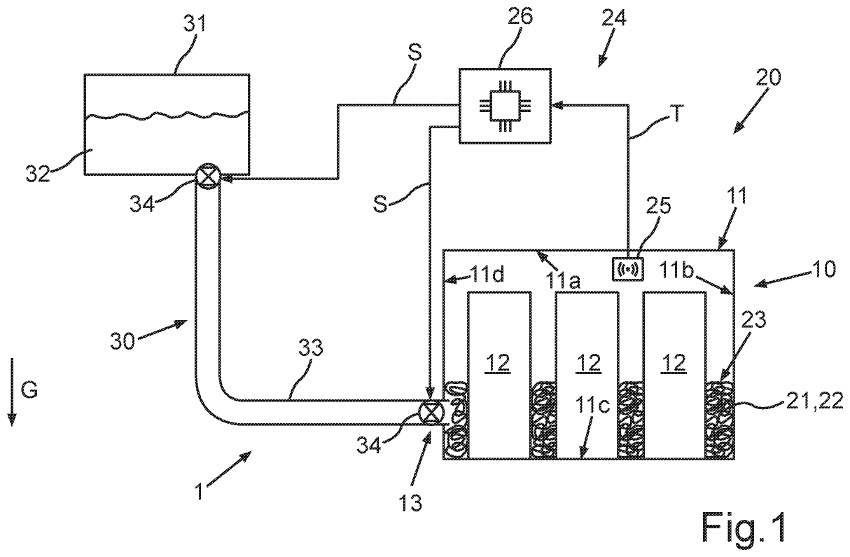

In order to avoid such thermal runaway, that is to say overheating of the battery or its components, there is provided, as shown in FIG. 1, an electronics apparatus 1 or electronics protection apparatus for the battery. The electronics apparatus 1 according to FIG. 1 includes, in addition to the battery 10, a protection device 20 and a liquid storage device 30.

FIG. 1 schematically illustrates a sectional view of the battery 10 from a lateral perspective. Here, the battery 10 includes a housing 11 as a housing device and, by way of example, three battery modules 12 as electronics components or battery elements. In the present case, the housing 11 is illustrated in a rectangular shape. In the present case, the housing 11 accordingly includes, by way of example, four housing walls 11a, 11b, 11c, 11d. In an intended installation position of the battery 10 in a motor vehicle, the walls 11a and 11c can form, for example, a cover and a base of the battery housing 11. The housing walls 11b and 11d are accordingly designed as side walls of the housing 11. The battery modules 12 are integrated in the housing 11. In the present case, three battery modules 12 are illustrated by way of example, wherein the battery 10 can of course also be constructed from more or fewer battery modules 12. FIG. 1 illustrates the battery modules in a prismatic shape by way of example. It goes without saying that the battery modules can also be, for example, cylindrical or present in what is known as a pouch format.

The battery modules 12 are arranged stacked next to one another in the housing according to FIG. 1. Here, a stacking direction extends along a surface of the housing base 11c. In order to be fastened in the housing 11, the modules 12 are fitted or fastened, for example, to the bottom surface 11c, as shown in FIG. 1. Electrical contact between the modules 12 or, for example, with an on-board electrical system of the motor vehicle can be made, for example, at the upper end, that is to say in the region of the housing cover 11a or even through the housing cover.

The protection device 20 is provided in order to be able to cool the modules 12 as required. The protection device 20 has a liquid absorption unit 21 which is integrated into the housing 11. The liquid absorption unit 21 has a super-absorbent material 22, also called super absorber. In this case, a material with electrically insulating properties is selected for the super absorber. The super-absorbent material is therefore an electrical insulator or non-conductor. A suitable material for this purpose is, for example, silicic acid. Such a super absorber has the property of, when it comes into contact with liquid 32, such as water for example, absorbing and storing or holding the liquid. The liquid 32 is then bound in the super-absorbent material. That is to say, the liquid 32 cannot move or slosh around freely in the housing 11. When the liquid 32 is absorbed, the super-absorbent material 22 increases in volume, that is to say it expands. This can produce a gel-like consistency, which is called hydrogel for example.

As shown in FIG. 1, the super-absorbent material 22 in an absorption element is implemented with a specified geometric shaped body. In FIG. 1, the geometric shaped body is illustrated, for example, in the form of a composite thread or fiber which forms a loose volume structure. The absorption element 23 therefore has a batting-like structure. As an alternative, other geometric shapes are also conceivable in order to implement the absorption element 23. This will be discussed once again in more detail later.

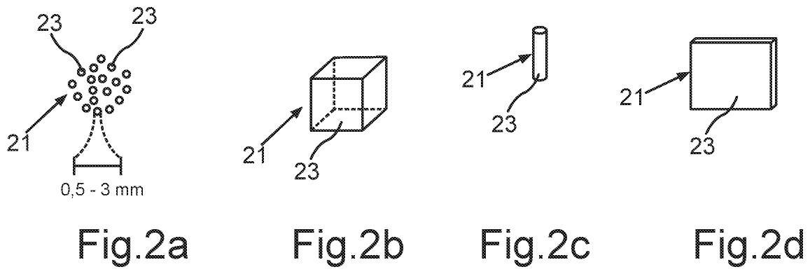

The property of the super-absorbent material 22 should then be used in order to cool the battery modules 12 as required. For this purpose, the absorption element 23 and therefore the super-absorbent material 22, as shown in FIG. 1, are arranged in the intermediate spaces in the battery housing 11 always between two adjacent battery modules 12 and in each case the side walls 11b and 11d and the adjoining battery module 12. The filling height selected for the super-absorbent material 22 is, by way of example, approximately one third of the distance between the housing base 11c and the housing cover 11a in FIG. 2. In addition to the option shown in FIG. 1, other options for filling and arranging the super-absorbent material 22 in the housing 11 are of course conceivable. These options will be discussed once again in more detail by way of example later.

The arrangement shown in FIG. 1 of the absorption element 23 in the housing 11 can then have the effect that the super-absorbent material 22 is placed partially or fully around modules 12 when the liquid 32 is absorbed and the material expands as a result. The battery modules 12 can therefore be sheathed or encased or surrounded by the super-absorbent material 22. If, in addition, a liquid 32 with a high thermal capacity, such as water for example, is used, a cooling water jacket can thus be formed around the defective battery modules 12. The heat from the defective battery modules can therefore be dissipated via the fully soaked super-absorbent material. In addition to the thermal capacity or heat storage capability, the energy that is required to evaporate the particles or molecules incorporated in the super-absorbent material can additionally also create an additional cooling effect here.

A further advantage of the sheathing is that, in the event of an increase in the temperature of the individual module 12, the bound liquid 32 in the super absorber 22 is heated at the contact area or interface between the respective battery module 12 and the super-absorbent material 22 and can then change over into a gaseous state. This additionally forms a gaseous layer or sheathing around the respective electronics component, and this can additionally create good thermal insulation. This can prevent other electronics components being carried along in a chain reaction due to one electronics component overheating.

The filling quantity or filling level of the super-absorbent material can be matched, for example, to the desired casing surface, around the electronics component, that is to say or a desired sheathing. That is to say, the filling quantity is selected such that a specified surface area of the electronics component is covered by the super-absorbent material 22 in the state in which the material is fully soaked with a specified quantity of liquid. The quantity of liquid 32, that is to say a liquid volume, up to the desired sheathing can be adjusted, for example. As an alternative or in addition, the quantity of liquid 32 can be specified, for example, by saturation of the super-absorbent material 22.

In order to identify when cooling of the battery 10 is required, the protection device 20 has a monitoring unit 24. The monitoring unit 24 can be used to monitor a temperature of the battery modules 12. If a specified temperature overshooting is detected here, a control signal S can be provided in order to request the liquid 32. As shown in FIG. 1, the monitoring unit 24 has a temperature sensor 25 and a controller 26 for this purpose. The temperature sensor 25 is integrated into the housing 11 and designed to monitor the temperature in the interior of the housing and therefore of the battery modules 12. As an alternative to the illustration shown in FIG. 1, a dedicated temperature sensor 25 can be assigned to each battery module, for example.

The temperature sensor 25 detects a temperature value T in order to monitor the temperature. The temperature sensor 25 provides the temperature value to the controller 26 for evaluation purposes. The controller 26 compares the measured temperature value T with a specified temperature limit value. If the temperature value T exceeds the limit value, the abovementioned temperature overshooting is present and the battery modules 12 or the housing 11 have heated up to such an extent that cooling is necessary. The controller then provides a respective control signal S to a liquid storage device 30. The control signal S is used to request the liquid 32 in order to cool the battery 10.

In order to provide the liquid 32, the liquid storage device 30 has a reservoir 31 and a provision mechanism. The liquid 32 can be stored or kept in the reservoir 31. In the present case, the reservoir 31 is illustrated as a tank, for example. The provision mechanism is provided in order to be able to pass on the liquid 32 from the reservoir to the super-absorbent material 22. This is illustrated, by way of example, in the form of a line 33, which opens out in an opening 13 of the housing 11, in FIG. 1.

In FIG. 1, the opening 13 is, for example, an artificially produced opening 13 which is made in the housing. A position of the opening 13 in the housing can be matched, for example, to a direction of action G of gravity. According to FIG. 1, gravity acts in the direction of the base 11c of the housing 11 when the battery 10 is in the intended installation position. The opening 13 can therefore be made above the base 11c. Therefore, gravity can be used in order to direct the liquid 32 in the direction of the super-absorbent material 22. In the present case, the opening 13 is made, by way of example, on the side wall 11d approximately at the filling level of the super-absorbent material 22. This gives rise to the advantage that the absorption element 23 and therefore the super-absorbent material 22 can be supplied with liquid 32 directly via the opening 13. The liquid 32 can therefore be bound by the super-absorbent material immediately as it enters the housing 11, so that there is no free liquid in the housing. As an alternative to the possible configuration illustrated in FIG. 1, it goes without saying that a plurality of openings can also be distributed over the housing 11 or provided on a different housing walls 11a, 11b, 11c, 11d. For example, a separate opening can be provided for each intermediate space in the battery housing between two adjacent battery modules and/or between a battery module 12 and the adjacent housing wall 11b, 11d.

In order to prevent liquid 32 from also being provided from the liquid storage device 30 to the battery in the normal case, that is to say without a defect or overheating being detected, the liquid storage device according to FIG. 1 has two valves as shut-off elements 34. These valves can be actuated by a respective control signal S, which is provided by the controller 26 when overheating is detected, and as a result can be opened, for example, until the desired cooling effect or quantity of liquid is reached. Flow of liquid between the reservoir 31 and the opening 13 is possible in this way. For example, a quantity or a volume of the liquid 32 can be adjusted by actuating the valves. The valves can then be closed again by further actuation.

A suitable liquid 32 is, for example, an electrically substantially non-conductive liquid, such as distilled water for example.

The liquid absorption device 30 can be installed or provided in a motor vehicle, for example especially for the electronics apparatus 1. As an alternative, a liquid storage device 30, which is already present in the motor vehicle, can also be used for example. Such an existing liquid storage device 30 can be implemented, for example, by a windshield wiper system or a cooling liquid system. The liquid 32 provided to the super-absorbent material 22 is then, for example, a wiping water solution or a cooling liquid. Therefore, no additional components need to be integrated into the motor vehicle and it is possible to react to fluctuations in the temperature of the battery 10 particularly quickly.

FIGS. 2a to 2d illustrate different refinements or exemplary embodiments of the shaped body of the absorption element 23 of the liquid absorption unit 21. In FIG. 2a, the liquid absorption unit 21 is implemented, for example, by granules composed of super-absorbent material 22. The individual grains or granule elements are the absorption elements 23 of the liquid absorption unit 21 here. As shown in FIG. 2a, a diameter of the grains can be, for example, 0.5 to 3 millimeters. Such granules have a high surface structure and as a result can absorb the liquid 32 particularly effectively and rapidly.

FIG. 2b illustrates the shaped body of the absorption element 23 in a further possible configuration, by way of example as a cube or cuboid. The absorption element is therefore a solid body with a geometric basic shape. It goes without saying that other basic shapes for the shaped body are also conceivable. This gives rise to the advantage that a plurality of basic shapes can be combined to form any desired different bodies. The shape of the liquid absorption unit 21 can therefore be particularly easily matched to the free surfaces or intermediate spaces in the housing 11.

In a further alternative possible configuration according to FIG. 2c, the shaped body of the absorption element 21 can be designed, for example, as a bar or rod. In the present case, bar means an elongate object, the diameter of which is in particular very much larger than its length. In the present case, the bar is illustrated in cylindrical form, for example. It goes without saying that a rectangular bar shape is also conceivable. The bar in FIG. 2c is a solid body. In contrast to this, the bar can also be implemented as a hollow body, for example as a pipe.

As shown in FIG. 2d, the shaped body of the absorption element 21 can be implemented, for example, as a plate according to a further possible configuration. In the present case, plate means, in particular, a component of which the length and/or width dimensions are very much larger than a thickness or height. However, here, the thickness is selected in such a way that the plate is inherently dimensionally stable. A configuration of the absorption element 23 as a plate gives rise to the advantage that the absorption element in the housing can be stacked, for example similarly to known cell separating elements, together with the battery modules 12. In addition, the absorption elements 23 can contribute to the stability or stabilization of the electronics apparatus 1.

A particular shape of the plate can be understood to be, for example, a film as the absorption element 23. Here, the thickness is selected to be further very much smaller than in the case of a plate, and therefore the film is inherently dimensionally unstable. Such a film has only a small installation space requirement and is suitable, for example, for adhesive bonding to or coating of the battery modules 12 and/or the housing 11.

In an absorption element 23 configured as a solid body, such as the plate or the bar or the geometric main body for example, it may be advantageous when the material is, for example, perforated or flow ducts are made in the material. This gives rise to the advantage that the liquid 32 can also enter inner or deeper layers of the absorption element 23 as quickly as possible and as a result the absorption properties of the liquid absorption unit 21 can be improved.

Instead of the battery 10 described in FIG. 1, the electronics apparatus 1 can of course also be used for other electronic devices, such as a control device or a battery management system for example.

Overall, the exemplary embodiments show how a super absorber can be used within a high-voltage battery or high-voltage electronics for improved fire protection.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1. An electronics apparatus for a motor vehicle, comprising:
at least one electronics component; and
a housing device having at least one opening permitting ingress of a liquid and a protection device for liquid absorption, integrated into the housing device and including super-absorbent material absorbing the liquid upon contact, electrically insulating when wet, and at least partially surrounding the at least one electronics component when the liquid is absorbed by the super-absorbent material.

2. The electronics apparatus according to claim 1, further comprising a monitor that monitors a temperature of the at least one electronics component and generates a control signal requesting the liquid when a specified temperature is exceeded.

3. The electronics apparatus according to claim 2, wherein the electronics apparatus is in a motor vehicle, and wherein a liquid storage device in the motor vehicle provides the liquid to the electronics apparatus, the liquid storage device having a reservoir holding the liquid and a provision mechanism actuated by the control signal to provide the liquid from the reservoir to the housing device via the at least one opening.

4. The electronics apparatus according to claim 3, wherein the liquid storage device holds one of windshield wiper solution provided to a windshield wiper cooling liquid provided to a cooling liquid system.

5. The electronics apparatus according to claim 4, wherein the super-absorbent material is provided in at least one absorption element having a geometric shaped body arranged in the housing device at least one of between a housing wall and the at least one electronics component and between at least two adjacent electronics components among the at least one electronics component.

6. The electronics apparatus according to claim 5, wherein the geometric shaped body is one of granules, a plate, a film, a rod, an individual thread, and a thread composite in one of a woven fabric and a loose volume structure.

7. The electronics apparatus according to claim 6, wherein the geometric shaped body has one of a porous structure and a perforated structure.

8. The electronics apparatus according to claim 7, wherein the geometric shaped body has a plurality of flow ducts transporting the liquid in one of different layers of the geometric shaped body and completely through the geometric shaped body.

9. The electronics apparatus according to claim 8,
wherein the electronics apparatus includes a battery arrangement for the motor vehicle,
wherein the housing device of the electronics apparatus is a battery housing of the battery arrangement, and
wherein the at least one electronics component of the electronics apparatus is at least one battery element of the battery arrangement.

10. The electronics apparatus according to claim 1, wherein the electronics apparatus is in a motor vehicle, and wherein a liquid storage device in the motor vehicle provides the liquid to the electronics apparatus, the liquid storage device having a reservoir holding the liquid and a provision mechanism actuated by the control signal to provide the liquid from the reservoir to the housing device via the at least one opening.

11. The electronics apparatus according to claim 10, wherein the liquid storage device holds one of windshield wiper solution provided to a windshield wiper cooling liquid provided to a cooling liquid system.

12. The electronics apparatus according to claim 1, wherein the super-absorbent material is provided in at least one absorption element having a geometric shaped body arranged in the housing device at least one of between a housing wall and the at least one electronics component and between at least two adjacent electronics components among the at least one electronics component.

13. The electronics apparatus according to claim 12, wherein the geometric shaped body is one of granules, a plate, a film, a rod, an individual thread, and a thread composite in one of a woven fabric and a loose volume structure.

14. The electronics apparatus according to claim 12, wherein the geometric shaped body has one of a porous structure and a perforated structure.

15. The electronics apparatus according to claim 12, wherein the geometric shaped body has a plurality of flow ducts transporting the liquid in one of different layers of the geometric shaped body and completely through the geometric shaped body.

16. The electronics apparatus according to claim 1,
wherein the electronics apparatus is in a motor vehicle and includes a battery arrangement for the motor vehicle,
wherein the housing device of the electronics apparatus is a battery housing of the battery arrangement, and
wherein the at least one electronics component of the electronics apparatus is at least one battery element of the battery arrangement.

17. A motor vehicle, comprising:
a liquid storage device storing a liquid; and
an electronics apparatus including
at least one electronics component; and
a housing device having
at least one opening permitting ingress of a liquid, and
a protection device for liquid absorption, integrated into the housing device and including super-absorbent material absorbing the liquid upon contact, electrically insulating when wet, and at least partially surrounding the at least one electronics component when the liquid is absorbed by the super-absorbent material.

18. The motor vehicle according to claim 17,
further comprising a monitor that monitors a temperature of the at least one electronics component and generates a control signal requesting the liquid when a specified temperature is exceeded, and
wherein the liquid storage device has a reservoir holding the liquid and a provision mechanism actuated by the control signal to provide the liquid from the reservoir to the housing device via the at least one opening.

19. The motor vehicle according to claim 18, wherein the liquid storage device holds one of windshield wiper solution provided to a windshield wiper cooling liquid provided to a cooling liquid system.

20. The motor vehicle according to claim 17, wherein the super-absorbent material is provided in at least one absorption element having a geometric shaped body arranged in the housing device at least one of between a housing wall and the at least one electronics component and between at least two adjacent electronics components among the at least one electronics component.
